(19) United States
(12) Patent Application Publication
(10) Pub. No.: US 2019/0384687 A1
(43) Pub. Date: Dec. 19, 2019

(54) INFORMATION PROCESSING DEVICE, INFORMATION PROCESSING METHOD, AND COMPUTER READABLE MEDIUM

(71) Applicant: MITSUBISHI ELECTRIC CORPORATION, Tokyo (JP)

(72) Inventors: Koki MURANO, Tokyo (JP); Noriyuki MINEGISHI, Tokyo (JP); Yoshihiro OGAWA, Tokyo (JP); Tomomi TAKEUCHI, Tokyo (JP)

(73) Assignee: MITSUBISHI ELECTRIC CORPORATION, Tokyo (JP)

(21) Appl. No.: 16/471,925

(22) PCT Filed: Feb. 20, 2017
(86) PCT No.: PCT/JP2017/006220

§ 371 Date: Jun. 20, 2019

(51) Int. Cl. G06F 11/34; G06F 17/50; G06F 8/41

(52) U.S. Cl. CPC G06F 11/3447; G06F 17/5045; G06F 2201/865; G06F 8/452; G06F 11/3457; G06F 17/5022

(57) ABSTRACT

A processing dividing unit (130) extracts, from a function model (210) including one or more loop processes, each of the one or more loop processes. A parameter extracting unit (140) determines the characteristics of each extracted loop process. A performance calculation basic formula selecting unit (150) selects, for each loop process, from a plurality of processing time calculation procedures for calculating a processing time, a processing time calculation procedure for calculating a processing time of each loop process, based on the characteristics of each loop process and the architecture of computational resources executing the function model (210). A performance estimating unit (160) calculates a processing time of each loop process by using a corresponding processing time calculation procedure selected by the performance calculation basic formula selecting unit (150).

### TECHNICAL FIELD

The present invention relates to a technique of calculating a processing time of a program.

### BACKGROUND ART

An embedded system is configured by combining computational resources such as a CPU (Central Processing Unit), a DSP (Digital Signal Processor), a GPU (Graphic Processing Unit), and an FPGA (Field Programmable Gate Array), a memory, an IC (Integrated Circuit), and the like. Making a selection from these computational resources, making a selection of a memory and an IC, and determining a connection configuration of the computational resources and the memory and the IC are called system architecture design.

Conventionally, system architecture designing has been carried out based on experiences and the like of a designer. A simulation model of software and hardware operating on computational resources is used to simulate an embedded system, so as to make a performance estimation of the embedded system.

However, the method of performance estimation described above requires designing the system architecture once and then creating a simulation model for each of the computational resources and the memory that constitute the system. Accordingly, there is a problem that a large number of steps are needed to develop a simulation model. There is also a problem that the simulation models need to be changed every time the system architecture is changed.

There is also a problem that a time for performing simulation using the simulation models for estimating performance is also necessary, making the performance estimation time consuming.

In order to solve these problems, methods of utilizing performance values on a database without performing simulation is disclosed in Patent Literature 1 and Patent Literature 2.

Patent Literature 1 discloses a method of estimating performance of a processor. More specifically, Patent Literature 1 discloses a method of estimating performance of a processor by storing instruction execution times of the processor in a database in advance, and applying the instruction execution times of the processor to arithmetic operations included in a source code.

Patent Literature 2 discloses a method of estimating performance of a parallel processor such as a GPU. More specifically, Patent Literature 2 discloses a method of estimating performance of a parallel processor when a loop is parallelized, by obtaining the number of loops from a function model, and dividing the obtained number of loops by the number of cores of the parallel processor.

### CITATION LIST

### Patent Literature

Patent Literature 1: JP 2005-242569A

Patent Literature 2: JP 2014-194660A

### SUMMARY OF INVENTION

### Technical Problem

However, even when these methods are used, there is a problem that the performance estimation cannot be carried out when the function model is mounted based on the architecture of computational resources, and thus accuracy of estimation values is low.

A main object of the present invention is to solve this problem. More specifically, the present invention mainly aims to realize performance estimation with high accuracy that reflects the architecture of computational resources without performing simulation.

### Solution to Problem

An information processing device according to the present invention includes:

a loop extracting unit to extract, from a program including one or more loop processes, each of the one or more loop processes;

a characteristics determining unit to determine characteristics of each loop process extracted by the loop extracting unit;

a calculation procedure selecting unit to select, for each loop process, from a plurality of processing time calculation procedures for calculating a processing time, a processing time calculation procedure for calculating a processing time of each loop process, based on the characteristics of each loop process determined by the characteristics determining unit and architecture of computational resources executing the program; and

a processing time calculating unit to calculate a processing time of each loop process by using a corresponding processing time calculation procedure selected by the calculation procedure selecting unit.

### Advantageous Effects of Invention

According to the present invention, it is possible to realize performance estimation with high accuracy that reflects the architecture of computational resources without performing simulation.

### BRIEF DESCRIPTION OF DRAWINGS

FIG. 1 is diagram illustrating a functional configuration example of a performance estimating device according to a first embodiment.

FIG. 2 is a diagram illustrating a hardware configuration example of the performance estimating device according to the first embodiment.

FIG. 3 is a flowchart illustrating an operation example of the performance estimating device according to the first embodiment.

FIG. 4 is a flowchart illustrating an operation example of the performance estimating device according to the first embodiment.

FIG. 5 is a diagram illustrating an example of a function model according to the first embodiment.

FIG. 6 is a diagram illustrating an example of a loop process according to the first embodiment.

FIG. 7 is a diagram illustrating an example of a loop process having data dependence between iterations according to the first embodiment.

FIG. 8 is a diagram illustrating an example of a loop process having control dependence according to the first embodiment.

FIG. 9 is a diagram illustrating an example of a loop process in which a contraction operation is possible according to the first embodiment.

FIG. 10 is a diagram illustrating a parameter extraction example of the loop process according to the first embodiment.

FIG. 11 is a diagram illustrating an example of performance calculation basic formula information according to the first embodiment.

FIG. 12 is a diagram illustrating an example of constraint condition information according to the first embodiment.

FIG. 13 is a diagram illustrates an example of memory access delay characteristics information according to the first embodiment.

FIG. 14 is a diagram illustrating an example of arithmetic operation time information according to the first embodiment.

### DESCRIPTION OF EMBODIMENTS

Embodiments of the present invention will be explained below with reference to drawings. In the following descriptions of the embodiments and the drawings, elements denoted by the same reference signs indicate the same or corresponding parts.

### First Embodiment

### ***Descriptions of Configurations***

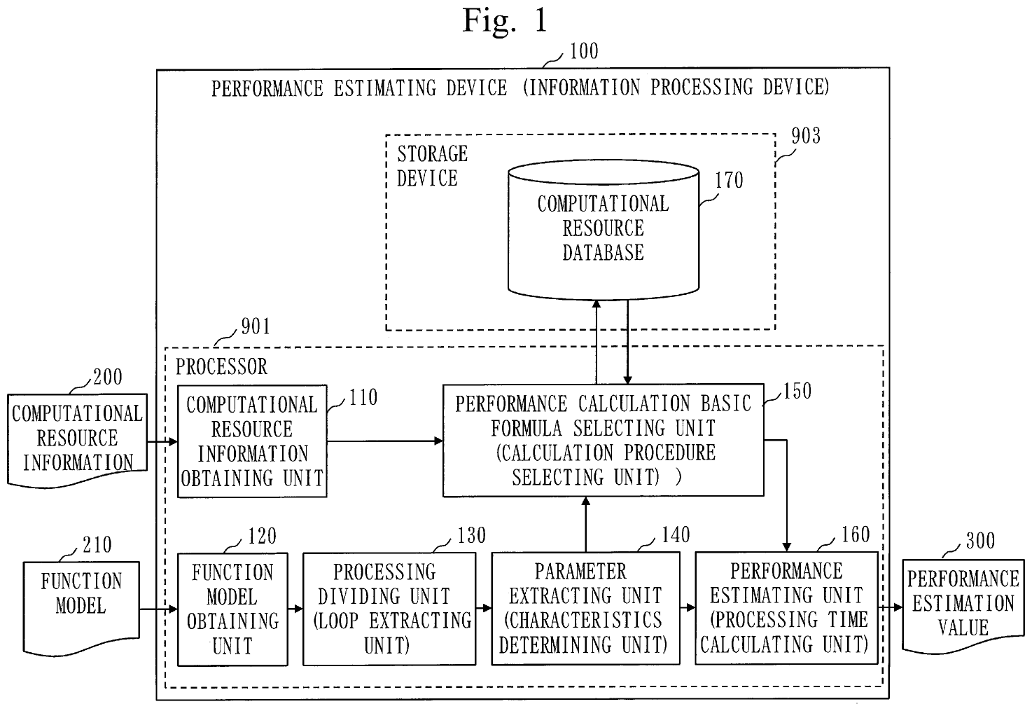

FIG. 1 illustrates a functional configuration example of a performance estimating device 100 according to a first embodiment. A functional configuration of the performance estimating device 100 according to the first embodiment will be described based on FIG. 1. However, the functional configuration of the performance estimating device 100 may be different from the functional configuration in FIG. 1.

The performance estimating device 100 includes a computational resource information obtaining unit 110, a function model obtaining unit 120, a processing dividing unit 130, a parameter extracting unit 140, a performance calculation basic formula selecting unit 150, a performance estimating unit 160, and a computational resource database 170.

The performance estimating device 100 obtains computational resource information 200 and a function model 210, and outputs performance estimation value 300.

The performance estimating device 100 corresponds to an information processing device. Operations performed by the performance estimating device 100 correspond to an information processing method and an information processing program.

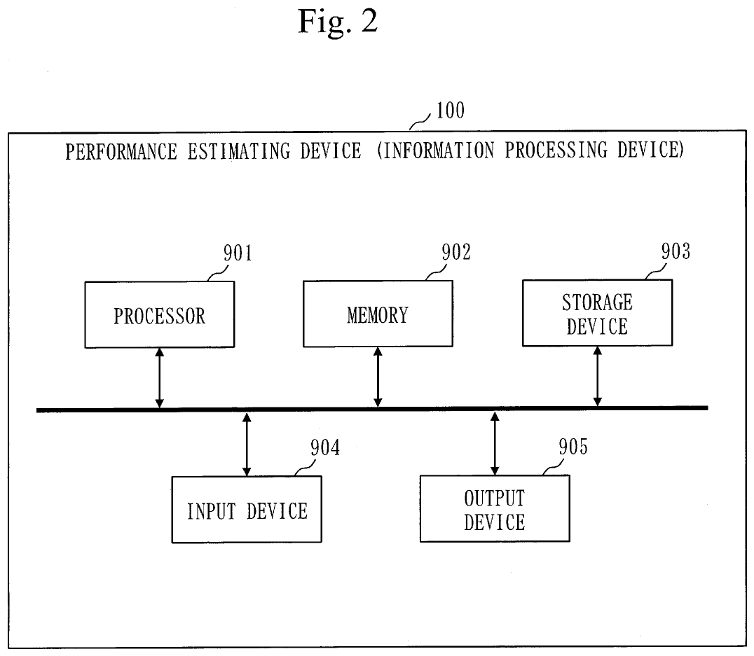

FIG. 2 illustrates a hardware configuration example of the performance estimating device 100 according to the first embodiment.

The performance estimating device 100 includes a processor 901, a memory 902, a storage device 903, an input device 904, and an output device 905.

The performance estimating device 100 is a computer.

The storage device 903 stores therein a program for realizing functions of the computational resource information obtaining unit 110, the function model obtaining unit 120, the function model obtaining unit 120, the processing dividing unit 130, the parameter extracting unit 140, the performance calculation basic formula selecting unit 150, and the performance estimating unit 160, which are described in FIG. 1.

The program is loaded into the memory 902. The processor 901 then reads the program from the memory 902 to execute the program, and performs operations of the computational resource information obtaining unit 110, the function model obtaining unit 120, the function model obtaining unit 120, the processing dividing unit 130, the parameter extracting unit 140, the performance calculation basic formula selecting unit 150, and the performance estimating unit 160, described later.

FIG. 1 schematically illustrates a state that the processor 901 executes the program for realizing the functions of the computational resource information obtaining unit 110, the function model obtaining unit 120, the function model obtaining unit 120, the processing dividing unit 130, the parameter extracting unit 140, the performance calculation basic formula selecting unit 150, and the performance estimating unit 160.

Next, details of the constituent elements illustrated in FIG. 1 are explained.

The computational resource information obtaining unit 110 obtains the computational resource information 200. The computational resource information 200 indicates the architecture of computational resources executing the function model 210. A process as the target of performance estimation is described in the function model 210. The function model 210 is all or a part of a source code of the program, for example. The function model 210 includes one or more loop processes. The computational resources are arithmetic devices that execute a program. As described above, the computational resources include a CPU, a DSP, a GPU, an FPGA, and the like. The architecture of the computational resources is a specific model number of a computational resource, such as a product name and a product code.

The computational resource information obtaining unit 110 outputs the computational resource information 200 to the performance calculation basic formula selecting unit 150.

The function model obtaining unit 120 obtains the function model 210. Input of the function model 210 to the function model obtaining unit 120 is performed by a user who uses the performance estimating device 100.

The processing dividing unit 130 divides the function model 210 obtained by the function model obtaining unit 120. More specifically, the processing dividing unit 130 extracts a loop process from the function model 210.

The loop process is a process represented by a for statement or the like when the function model 210 is a program of the C language, for example. When the function model 210 is a program of the C language, the processing dividing unit 130 extracts a portion enclosed by a for statement as one loop, or extracts a process description between a for statement and a for statement as a loop having a loop count of one.

The processing dividing unit 130 outputs the function model 210 divided for each loop process to the parameter extracting unit 140.

The function model obtaining unit 120 corresponds to a loop extracting unit. The process performed by the function model obtaining unit 120 corresponds to a loop extracting process.

The parameter extracting unit 140 determines the characteristics of each loop process extracted by the processing dividing unit 130. The parameter extracting unit 140 extracts a memory access size and a memory access order of a whole loop process from each loop process extracted by the processing dividing unit 130. The parameter extracting unit 140 also extracts, from each loop process extracted by the processing dividing unit 130, the number of arithmetic operations for each arithmetic operation type in the loop process.

The parameter extracting unit 140 determines presence/absence of data dependence between iterations of a loop process, the number of branch processes included in the loop process (the number of control dependence of processes in the loop process), and a possibility of contraction operation of the loop process, as the characteristics of the loop process. The characteristics of the loop process are not limited to these.

The parameter extracting unit 140 outputs the characteristics of each loop process to the performance calculation basic formula selecting unit 150.

The parameter extracting unit 140 outputs the extracted memory access size, memory access order, and the number of arithmetic operations for each arithmetic operation type, to the performance estimating unit 160.

The parameter extracting unit 140 corresponds to a characteristics determining unit. A process performed by the parameter extracting unit 140 corresponds to a characteristics determining process.

The performance calculation basic formula selecting unit 150 selects an optimum performance calculation basic formula from a plurality of performance calculation basic formulas retained in the computational resource database 170. The performance calculation basic formula is a processing time calculation procedure for calculating a processing time of a loop process. The performance calculation basic formula selecting unit 150 selects an optimum performance calculation basic formula for each loop process. More specifically, the performance calculation basic formula selecting unit 150 selects an optimum performance calculation basic formula for each loop process, based on constraint conditions indicated in constraint condition information output from the computational resource database 170, the characteristics of the loop process determined by the parameter extracting unit 140, and the architecture of computational resources indicated in the computational resource information 200.

The performance calculation basic formula selecting unit 150 outputs the selected performance calculation basic formula to the performance estimating unit 160.

The performance calculation basic formula selecting unit 150 corresponds to a calculation procedure selecting unit. A process performed by the performance calculation basic formula selecting unit 150 corresponds to a calculation procedure selecting process.

The performance estimating unit 160 obtains a performance calculation basic formula from the performance calculation basic formula selecting unit 150.

The performance estimating unit 160 obtains memory access delay characteristics information from the computational resource database 170. The performance estimating unit 160 applies the memory access size and the memory access order extracted by the parameter extracting unit 140 to the memory access delay characteristics information, so as to calculate a memory access time in a loop process.

The performance estimating unit 160 obtains arithmetic operation time information from the computational resource database 170. The performance estimating unit 160 applies the number of arithmetic operations for each arithmetic operation type in the loop process extracted by the parameter extracting unit 140 to the arithmetic operation time information, so as to calculate an arithmetic operation time (instruction execution time) in the loop process.

The performance estimating unit 160 applies the calculated memory access time and arithmetic operation time (instruction execution time) to the performance calculation basic formula obtained from the performance calculation basic formula selecting unit 150. The performance estimating unit 160 obtains a processing time of the whole loop process.

The performance estimating unit 160 obtains a processing time of the whole function model 210 from a processing time of each loop process. The performance estimating unit 160 outputs the processing time of the whole function model 210 as the performance estimation value 300.

The performance estimating unit 160 corresponds to a processing time calculating unit. A process performed by the performance estimating unit 160 corresponds to a processing time calculating process.

The computational resource database 170 retains performance calculation basic formula information. The computational resource database 170 also retains constraint condition information. The computational resource database 170 further retains memory access delay characteristics information and arithmetic operation time information of each arithmetic operation.

The computational resource database 170 is realized by the storage device 903.

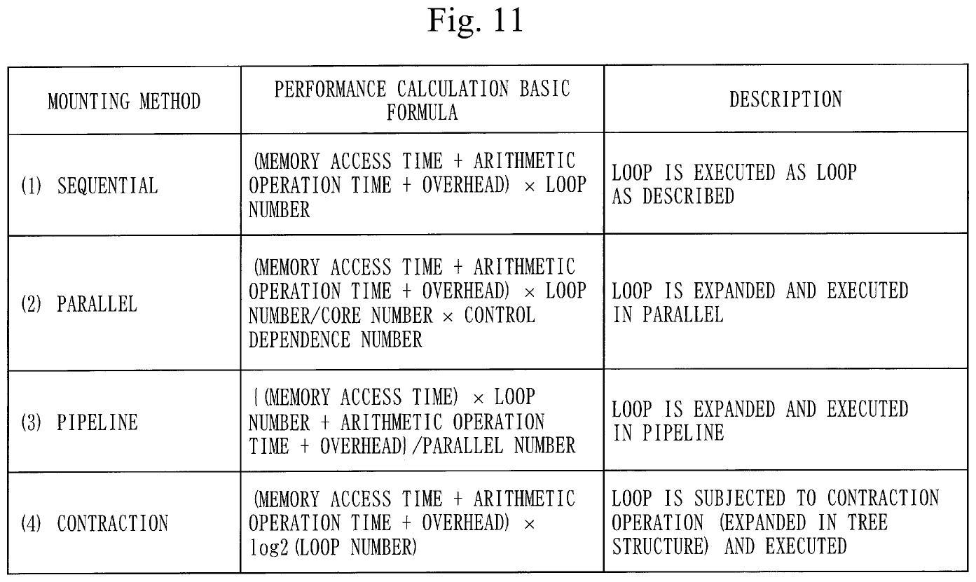

A plurality of performance calculation basic formulas is described in the performance calculation basic formula information. FIG. 11 illustrates an example of the performance calculation basic formula information. Details of the performance calculation basic formula information will be described later.

Four performance calculation basic formulas are described in the performance calculation basic formula information of FIG. 11. Further, a field of description is provided as supplementary information for understanding each performance calculation basic formula. The performance calculation basic formula information retained in the computational resource database 170 does not need to have the field of description.

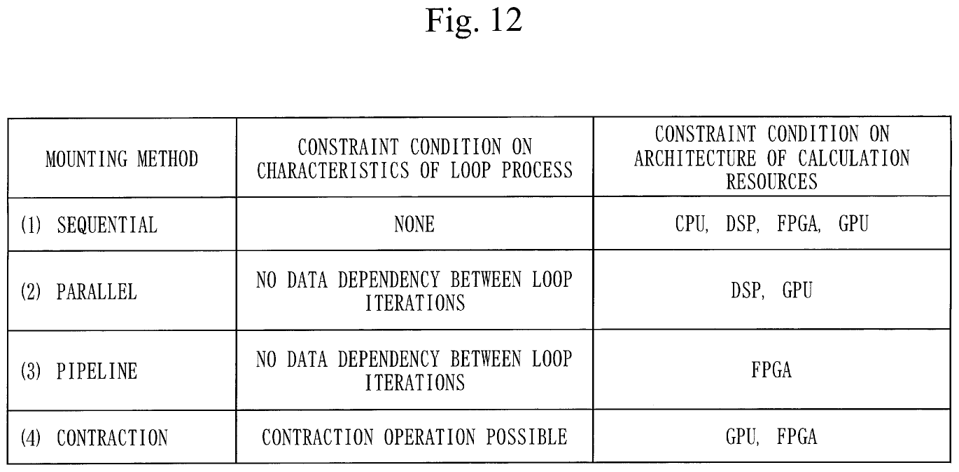

Constraint conditions are described in the constraint condition information for each performance calculation basic formula. An example of the constraint condition information is illustrated in FIG. 12. In the constraint condition information of FIG. 12, constraint conditions on the characteristics of a loop process and constraint conditions on the architecture of computational resources are defined. Details of the constraint condition information will be described later. The constraint conditions on the characteristics of a loop process describe the characteristics of a loop process to be applied of the performance calculation basic formula. The constraint conditions on the architecture of computational resources describe the architecture of computational resources to be applied of the performance calculation basic formula.

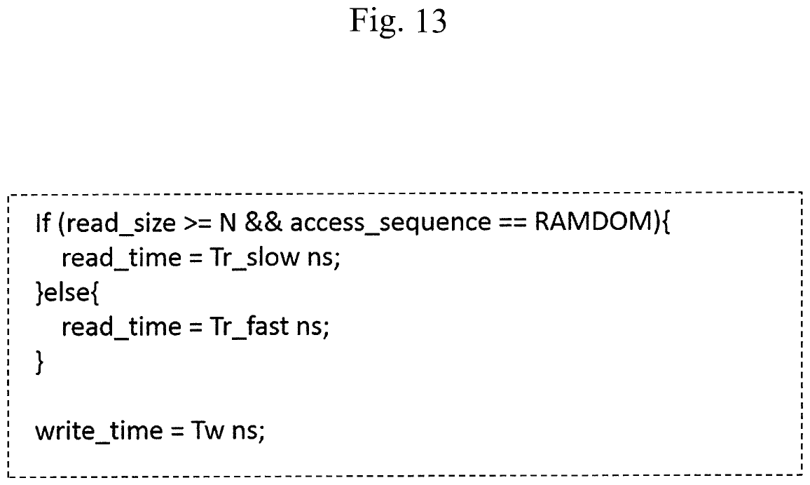

A calculation procedure for memory access delay time is described in the memory access delay characteristics information. FIG. 13 illustrates an example of the memory access delay characteristics information. Details of the memory access delay characteristics information will be described later. The memory access delay characteristics information corresponds to a memory access delay time calculation procedure.

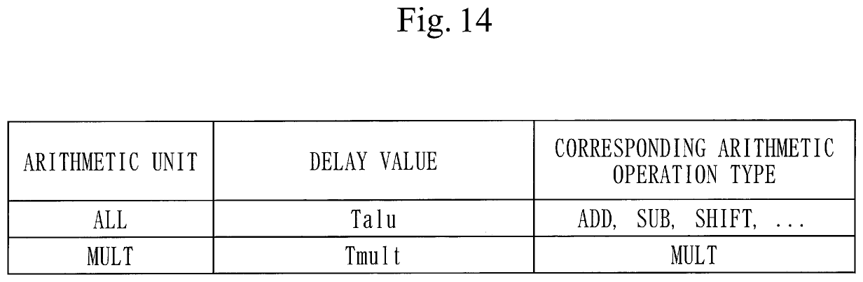

A calculation procedure for the arithmetic operation time is described in the arithmetic operation time information. FIG. 14 illustrates an example of the arithmetic operation time information. Details of the arithmetic operation time information will be described later.

***Descriptions of Operations***

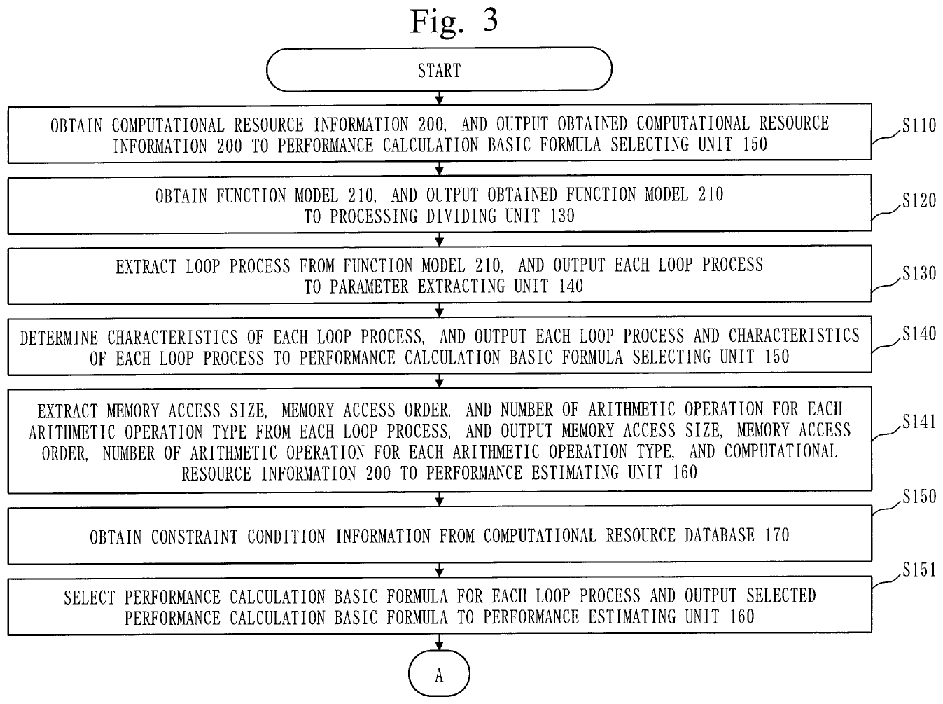

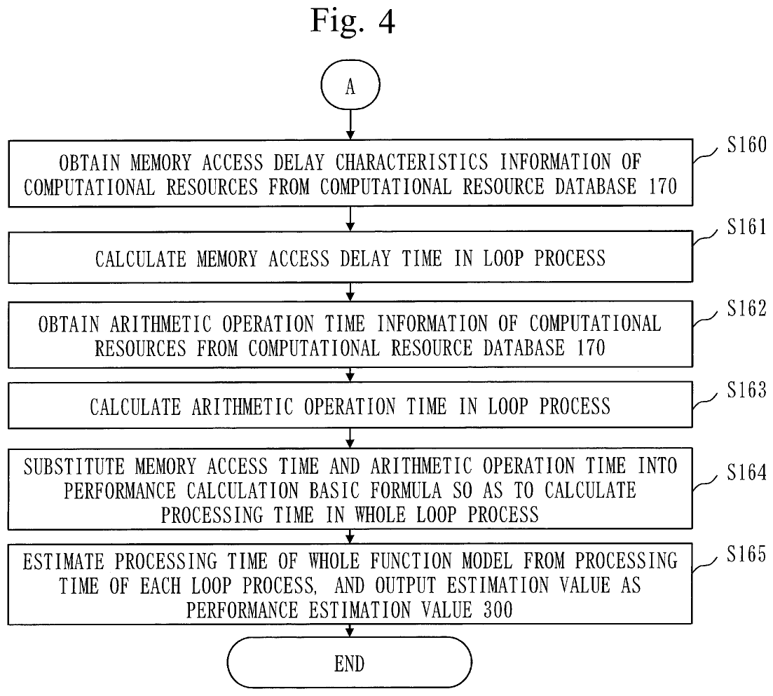

FIG. 3 and FIG. 4 illustrate an operation example of the performance estimating device 100 according to the first embodiment.

The operation example of the performance estimating device 100 according to the first embodiment will be described based on FIG. 3 and FIG. 4. However, operations of the performance estimating device 100 may include any process that is different from those in FIG. 3 and FIG. 4.

First, in Step S110, the computational resource information obtaining unit 110 obtains computational resource information 200, and outputs the obtained computational resource information 200 to the performance calculation basic formula selecting unit 150.

After Step S110, the process proceeds to Step S120.

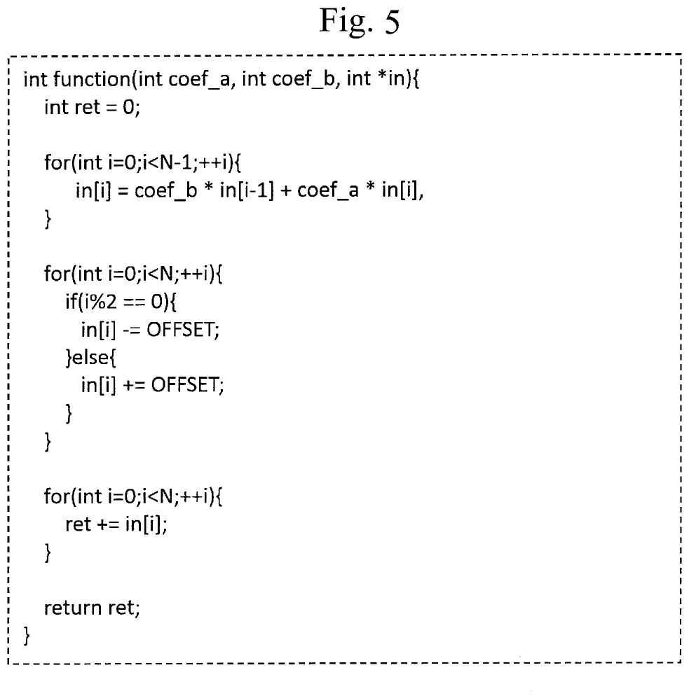

Next, in Step S120, the function model obtaining unit 120 obtains a function model 210, and outputs the obtained function model 210 to the processing dividing unit 130. The function model 210 is a process described in a programming language such as the C language, and is the whole or a part of an executable program. FIG. 5 illustrates an example of the function model 210.

After Step S120, the process proceeds to Step S130.

Next, in S130, the processing dividing unit 130 extracts a loop process from the function model 210, and outputs each loop process to the parameter extracting unit 140.

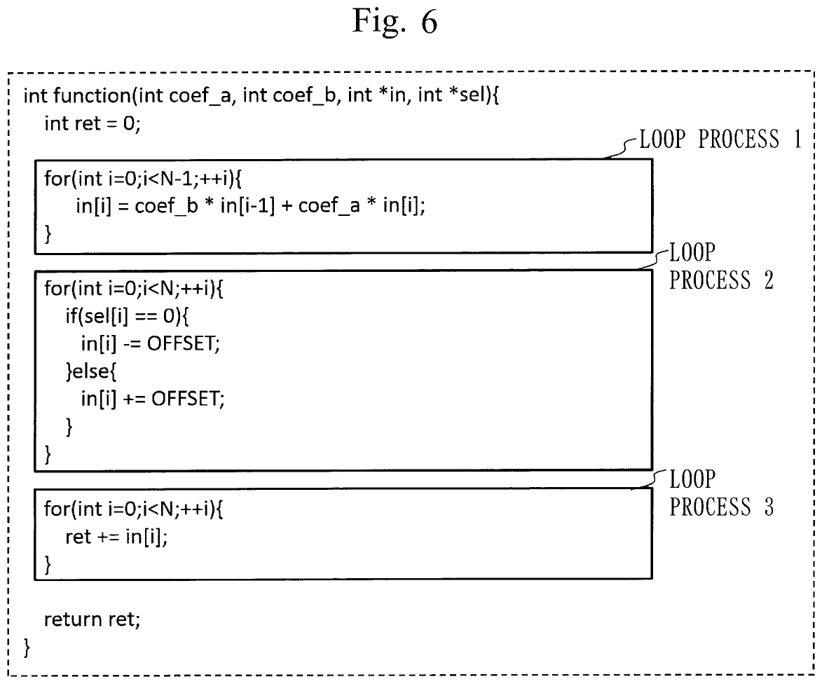

FIG. 6 illustrates an example of the loop process extracted from the function model 210 illustrated in FIG. 5.

After Step S130, the process proceeds to Step S140.

Next, in Step S140, the parameter extracting unit 140 determines the characteristics of each loop process. The parameter extracting unit 140 then outputs each loop process and the characteristics of each loop process to the performance calculation basic formula selecting unit 150. Examples of the characteristics of a loop process include the following.

### (1) Presence/Absence of Data Dependence Between Loop Iterations

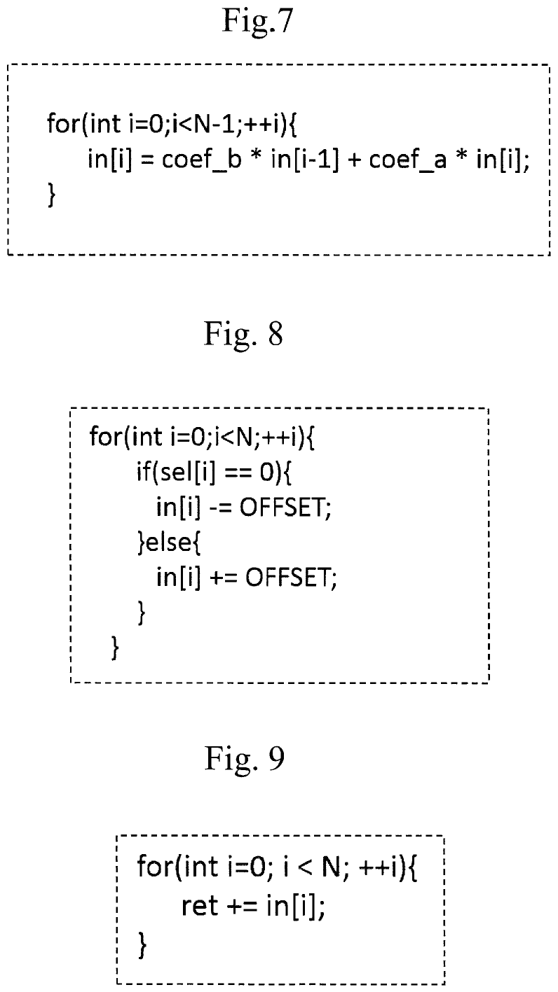

The parameter extracting unit 140 determines whether an execution order among a plurality of arithmetic operations included in a loop process is restricted or not. FIG. 7 illustrates an example of a loop process having data dependence.

### (2) Number of Branch Number Processes in Loop

When a branch process is included in a loop process, the parameter extracting unit 140 counts the number of branch processes. FIG. 8 illustrates an example of a loop process having control dependence, that is, a loop process including a branch process. In the case of the loop process in FIG. 8, since there is one branch process, the number of branch processes (also referred to as control dependence number) is one.

(3) Possibility of Contraction Operation of Loop p When a loop process includes an arithmetic operation whose arithmetic operation results are summarized into one variable and to which a commutative law is applicable, the parameter extracting unit 140 determines the loop process as a loop process in which a contraction operation is possible. FIG. 9 illustrates an example of the loop process in which a contraction operation is possible.

After Step S140, the process proceeds to Step S141.

In Step S141, the parameter extracting unit 140 extracts a memory access size, a memory access order (sequential or random), and the number of arithmetic operations for each arithmetic operation type, from each loop process. Subsequently, the parameter extracting unit 140 outputs the memory access size, the memory access order, the number of arithmetic operations for each arithmetic operation type, and the computational resource information 200 to the performance estimating unit 160.

The parameter extracting unit 140 extracts an operator, such as addition, subtraction, multiplication and division, a bit shift, or a logical operation as the arithmetic operation type. The parameter extracting unit 140 also extracts an arithmetic operation that is treated as one arithmetic operation on the architecture of computational resources such as a product-sum operation (a * c +b) as one arithmetic operation type.

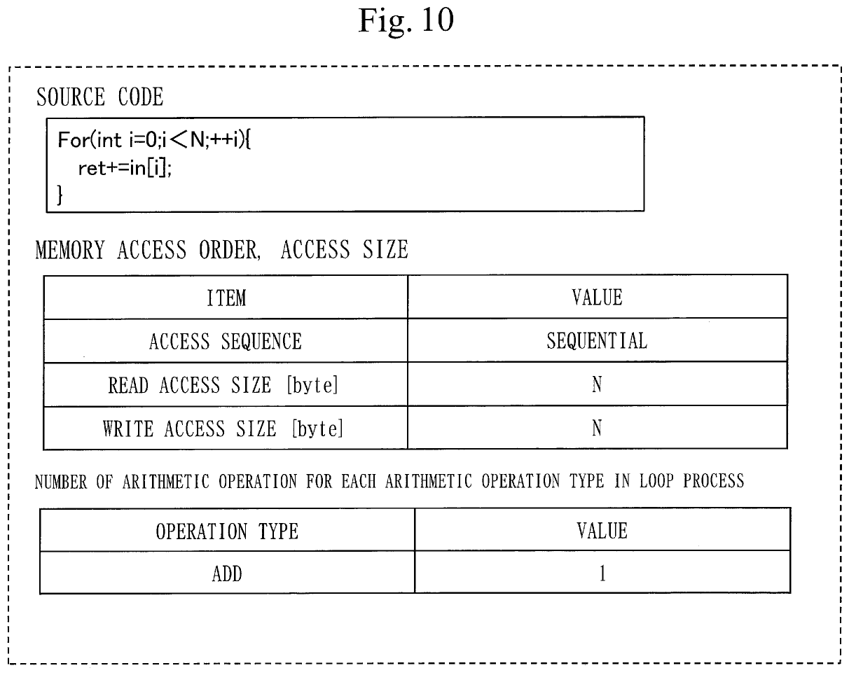

FIG. 10 illustrates a source code of a loop process and a parameter extraction example for the loop process by the parameter extracting unit 140.

After Step S141, the process proceeds to Step S150.

Next, in Step S150, the performance calculation basic formula selecting unit 150 obtains constraint condition information from the computational resource database 170.

An example of the constraint condition information is illustrated in FIG. 12.

After S150, the process proceeds to S151.

In Step S151, the performance calculation basic formula selecting unit 150 selects an optimum performance calculation basic formula for each loop process from a plurality of performance calculation basic formulas retained in the computational resource database 170 based on the characteristics of a loop process and the architecture of computational resources.

More specifically, the performance calculation basic formula selecting unit 150 compares a combination of the characteristics of the loop process determined by the parameter extracting unit 140 and the architecture of computational resources described in the computational resource information 200 with a combination of the constraint conditions on the characteristics of a loop process and the constraint conditions on the architecture of computational resources indicated in the constraint condition information obtained in Step S150, so as to select a performance calculation basic formula.

In FIG. 12, with respect to the performance calculation basic formula of “(1) sequential”, “none” is defined as a constraint condition on the characteristics of a loop process, and “CPU, DSP, FPGA, GPU” is defined as a constraint condition on the architecture of computational resources. With respect to the performance calculation basic formula of “(2) parallel”, “no data presence between loop iterations” is defined as a constraint condition on the characteristics of a loop process, and “DSP, GPU” is defined as a constraint condition on the architecture of computational resources. With respect to the performance calculation basic formula of “(4) contraction”, “contraction operation possible” is defined as a constraint condition on the characteristics of a loop process, and “GPU, FPGA” is defined as a constraint condition on the architecture of computational resources.

When the architecture of computational resources indicated in the computational resource information 200 is a model number belonging to a GPU, the performance calculation basic formula selecting unit 150 can select the performance calculation basic formulas of “(1) sequential”, “(2) parallel”, and “(4) contraction” as the performance calculation basic formula of the loop process. The loop process illustrated in FIG. 10 is a loop process which has data dependence between loop iterations, and is a loop process for which a contraction is possible. The performance calculation basic formula selecting unit 150 can select the performance calculation basic formula of “(1) sequential” or “(4) contraction” with respect to the loop process of FIG. 10. Here, the performance calculation basic formula of “(4) contraction” is better in performance, and thus the performance calculation basic formula selecting unit 150 selects the performance calculation basic formula of “(4) contraction”. Subsequently, the performance calculation basic formula selecting unit 150 obtains the selected performance calculation basic formula from the computational resource database 170, and outputs the obtained performance calculation basic formula to the performance estimating unit 160.

After Step S151, the process proceeds to Step S160.

In Step S160, the performance estimating unit 160 obtains memory access delay characteristics information from the computational resource database 170. The memory access delay characteristics information indicates a procedure of calculating a memory access delay time from a memory access order and a memory access size that depend on the memory architecture of computational resources. FIG. 13 illustrates an example of the memory access delay characteristics information.

The memory access delay characteristics information of FIG. 13 indicates that the access time is Tr_slow [ns] when the access size of a read access is N [byte] or more and the memory access order is random access. The memory access delay characteristics information of FIG. 13 indicates that the access time is Tr_fast [ns] when the access size and the memory access order of a read access are of conditions other than the ones described above. The memory access delay characteristics information of FIG. 13 also indicates that the access time of a write access is always Tw [ns]. The memory access delay characteristics information of FIG. 13 indicates the memory access delay characteristics of a computational resource having a cache of N [byte].

In the example of FIG. 13, while the memory access delay characteristics information is expressed in a format of programming language, the memory access delay characteristics information may be expressed in any other format such as a mathematical expression.

After Step S160, the process proceeds to Step S161.

In Step S161, the performance estimating unit 160 substitutes the memory access order and the memory access size obtained from the parameter extracting unit 140 in Step S141 into the memory access delay characteristics information obtained in S160, so as to calculate the memory access delay time in the loop process.

It is assumed that the memory access delay characteristics information of computational resources illustrated in FIG. 13 is used and the parameter extracting unit 140 extracts the access size and the memory access order illustrated in FIG. 10. In this case, since the access size=N [byte] and the read access order=sequential, the read access time Tr_fast [ns] and the write access time Tw [ns] are employed. Therefore, the memory access time in the loop process is (Tr_fast+Tw) [ns].

In Step S162, the performance estimating unit 160 obtains arithmetic operation time information of computational resources from the computational resource database 170. FIG. 14 illustrates an example of the arithmetic operation time information. As illustrated in FIG. 14, the arithmetic operation time information indicates a delay value and a corresponding arithmetic operation type of each arithmetic unit included in the computational resources.

After Step S162, the process proceeds to Step S163.

In Step S163, the performance estimating unit 160 calculates an arithmetic operation time in the loop process from the arithmetic operation time information obtained in Step S162 and the number of arithmetic operations for each arithmetic operation type extracted by the parameter extracting unit 140 in Step S141.

It is assumed that the arithmetic operation time information illustrated in FIG. 14 is used and the parameter extracting unit 140 extracts the number of arithmetic operations for each arithmetic operation type illustrated in FIG. 10. In the example of FIG. 10, since there is one ADD, the arithmetic operation time in the loop is Talu [ns]. If the loop process includes one ADD, one SUB, and one SHIFT, the arithmetic operation time in the loop is 3×Talu [ns].

After Step S163, the process proceeds to Step S164.

In Step 5164, the performance estimating unit 160 substitutes the memory access time in the loop process and the arithmetic operation time in the loop process that are calculated by the performance estimating unit 160 in Step S161 and Step S163 into the performance calculation basic formula selected by the performance calculation basic formula selecting unit 150 in Step S151, so as to calculate a processing time in the whole loop process.

When the performance calculation basic formula is “(4) contraction” of FIG. 11, the memory access delay in the loop process is (Tr_fast+Tw) [ns], the arithmetic operation time in the loop process is Talu [ns], and an overhead (fixed value) is OH [ns], the arithmetic operation time of the whole loop process is calculated as {(Tr_fast+Tw+Talu+OH)×log 2(N)} [ns].

For example, assuming that the same memory access delay time and arithmetic operation time as those described above are obtained when the performance calculation basic calculation formula 150 selects “(1) sequential” of FIG. 12, the arithmetic operation time of the whole loop process becomes {(Tr_fast+Tw+Talu+OH)×N} [ns].

In this manner, the performance calculation basic formula reflects a difference in processing time of a loop process that is caused by a method of installing the loop process.

After Step S164, the process proceeds to Step S165.

In Step S165, the performance estimating unit 160 calculates a processing time of the whole function model from the processing time of the whole of each loop process calculated in Step S164.

The performance estimating unit 160 calculates the processing time of the whole function model 210 by calculating the total sum of loop processes or a critical path, for example. In a case of a computational resource in which task parallelization is possible, the performance estimating unit 160 calculates the critical path by task scheduling. The computational resources in which task parallelization is possible are a multi-core CPU and an FPGA, for example.

The performance estimating unit 160 outputs the processing time of the whole function model 210 calculated as described above as the performance estimation value 300, thereby finishing the performance estimation process.

In the above descriptions, the computational resource database 170 retains one piece of memory access delay characteristics information and one piece of arithmetic operation time information for each computational resource. When one computational resource is adapted to a plurality of performance calculation basic formulas, the computational resource database 170 may retain the memory access delay characteristics information and the arithmetic operation time information in units of combinations of computational resources and performance calculation basic formulas.

In the example of FIG. 12, the GPU corresponds to “(1) sequential”, “(2) parallel”, and “(4) contraction”. The computational resource database 170 may retain memory access delay characteristics information and arithmetic operation time information with respect to a combination of the GPU and “(1) sequential”, memory access delay characteristics information and arithmetic operation time information with respect to a combination of the GPU and “(2) parallel”, and memory access delay characteristics information and arithmetic operation time information with respect to a combination of the GPU and “(4) contraction”.

Each piece of memory access delay characteristics information indicates a different calculation procedure, and each piece of arithmetic operation time information indicates a different calculation procedure.

***Descriptions of Effects of Embodiment***

The performance estimating device according to the present embodiment selects a performance calculation basic formula based on the characteristics of a loop process and the architecture of computational resources. The performance estimating device according to the present embodiment then calculates a processing time of the loop process by using the selected performance calculation basic formula. Accordingly, highly accurate performance estimation reflecting the architecture of computational resources can be realized without performing simulation.

***Descriptions of Hardware Configuration***

Finally, supplementary descriptions of a hardware configuration of the performance estimating device 100 are provided.

The processor 901 illustrated in FIG. 2 is an IC (Integrated Circuit) that performs processing.

The processor 901 is a CPU (Central Processing Unit), a DSP (Digital Signal Processor), or the like.

The memory 902 is a RAM (Random Access Memory).

The storage device 903 is a ROM (Read Only Memory), a flash memory, an HDD (Hard Disk Drive), or the like.

The input device 904 is, for example, a mouse or a keyboard.

The output device 905 is, for example, a display device.

Further, an OS (Operating System) is also stored in the storage device 903.

At least a part of the OS is executed by the processor 901.

The processor 901 executes the programs that realize the functions of the computational resource information obtaining unit 110, the function model obtaining unit 120, the function model obtaining unit 120, the processing dividing unit 130, the parameter extracting unit 140, the performance calculation basic formula selecting unit 150, and the performance estimating unit 160 while executing at least the part of the OS.

The processor 901 executes the OS, thereby performing task management, memory management, file management, communication control, and the like.

Further, at least pieces of information, data, signal values, and variable values indicating results of processing performed by the computational resource information obtaining unit 110, the function model obtaining unit 120, the function model obtaining unit 120, the processing dividing unit 130, the parameter extracting unit 140, the performance calculation basic formula selecting unit 150, and the performance estimating unit 160 are stored at least in any of the storage device 903, and a register and a cache memory in the processor 901.

Further, the programs that realize the functions of the computational resource information obtaining unit 110, the function model obtaining unit 120, the processing dividing unit 130, the parameter extracting unit 140, the performance calculation basic formula selecting unit 150, and the performance estimating unit 160 can be stored in portable storage medium such as a magnetic disk, a flexible disk, an optical disk, a compact disk, a Blue-ray (registered trademark) disk, and a DVD.

The “unit” of the computational resource information obtaining unit 110, the function model obtaining unit 120, the function model obtaining unit 120, the processing dividing unit 130, the parameter extracting unit 140, the performance calculation basic formula selecting unit 150, and the performance estimating unit 160 can be replaced with “circuit”, “step”, “procedure”, or “process”.

The performance estimating device 100 can be realized by an electronic circuit such as a logic IC (Integrated Circuit), a GA (Gate Array), an ASIC (Application Specific Integrated Circuit), and an FPGA (Field-Programmable Gate Array).

In this case, each of the computational resource information obtaining unit 110, the function model obtaining unit 120, the function model obtaining unit 120, the processing dividing unit 130, the parameter extracting unit 140, the performance calculation basic formula selecting unit 150, and the performance estimating unit 160 is realized as a part of the electronic circuit.

The processor and the electronic circuit described above are also collectively referred to as processing circuitry.

### REFERENCE SIGNS LIST

100: performance estimating device; 110: computational resource information obtaining unit; 120: function model obtaining unit; 130: processing dividing unit; 140: parameter extracting unit; 150: performance calculation basic formula selecting unit; 160: performance estimating unit; 170: computational resource database; 200: computational resource information; 210: function model; 300: performance estimation value; 901: processor; 902: memory; 903: storage device; 904: input device; 905: output device

1. An information processing device comprising:
processing circuitry to:
extract, from a program including one or more loop processes, each of the one or more loop processes;
determine characteristics of each loop process extracted;
select, for each loop process, from a plurality of processing time calculation procedures for calculating a processing time, a processing time calculation procedure for calculating a processing time of each loop process, based on the characteristics of each loop process determined and architecture of computational resources executing the program; and
calculate a processing time of each loop process by using a corresponding processing time calculation procedure selected.

2. The information processing device according to claim 1,
wherein the processing circuitry
selects, for each loop process, from a plurality of memory access delay time calculation procedures for calculating a memory access delay time, a memory access delay time calculation procedure for calculating a memory access delay time in each loop process, based on the architecture of computational resources executing the program, and
calculates a memory access delay time in each loop process by using a corresponding memory access delay time calculation procedure selected.
applies the memory access delay time obtained by calculation to the corresponding processing time calculation procedure so as to calculate the processing time of each loop process.

3. The information processing device according to claim 1,
wherein the processing circuitry
calculates an arithmetic operation time in each loop process based on a type and the number of arithmetic operations performed by each loop process, and
applies the arithmetic operation time obtained by calculation to the corresponding processing time calculation procedure so as to calculate the processing time of each loop process.

4. The information processing device according to claim 1,
wherein characteristics of a loop process to be applied and architecture of computational resources to be applied are defined in each of the plurality of processing time calculation procedures, and
the processing circuitry
compares characteristics of each loop process and architecture of computational resources executing the program with the characteristics of the loop process to be applied and the architecture of computational resource to be applied that are defined in each processing time calculation procedure, so as to select, for each loop process, a processing time calculation procedure for calculating the processing time of each loop process.

5. The information processing device according to claim 1,
wherein the processing circuitry determines, as characteristics of a loop process, at least one of presence/absence of data dependence between iterations of the loop process, the number of branch processes included in the loop process, and a possibility of contraction operation of the loop process.

6. The information processing device according to claim 1,
wherein the processing circuitry obtains a processing time of the program from a processing time of each loop process.

7. An information processing method comprising:
extracting from a program including one or more loop processes, each of the one or more loop processes;
determining characteristics of each loop process;
selecting for each loop process, from a plurality of processing time calculation procedures for calculating a processing time, a processing time calculation procedure for calculating a processing time of each loop process, based on the characteristics of each loop process and architecture of computational resources executing the program; and
calculating a processing time of each loop process by using a corresponding processing time calculation procedure.

8. A non-transitory computer readable medium storing a program for causing a computer to execute:
a loop extracting process of extracting, from a program including one or more loop processes, each of the one or more loop processes;
a characteristics determining process of determining characteristics of each loop process extracted by the loop extracting process;
a calculation procedure selecting process of selecting, for each loop process, from a plurality of processing time calculation procedures for calculating a processing time, a processing time calculation procedure for calculating a processing time of each loop process, based on the characteristics of each loop process determined by the characteristics determining process and architecture of computational resources executing the program; and
a processing time calculating process of calculating a processing time of each loop process by using a corresponding processing time calculation procedure selected by the calculation procedure selecting process.
